(19) United States
(12) Patent Application Publication
(10) Pub. No.: US 2023/0263294 A1
(43) Pub. Date: Aug. 24, 2023

(54) DEVICE FOR THE CLEANING OF MESIAL AND DISTAL SURFACES OF TEETH AND FIXED PROSTHESIS

(71) Applicant: ELEON PRODUCTS LTD, Airdrie (GB)

(72) Inventor: Michael ALATSARIS, Newbridge (GB)

(21) Appl. No.: 18/004,166

(22) PCT Filed: Jun. 29, 2021
(86) PCT No.: PCT/GB2021/051640

§ 371 Date: Jan. 3, 2023

Related U.S. Application Data
(60) Provisional application No. 63/047,933, filed on Jul. 3, 2020.

(51) Int. Cl. A46B 5/02; A46B 9/02

(52) U.S. Cl. CPC A46B 5/02; A46B 9/028; A46B 2200/1066

(57) ABSTRACT

A toothbrush product for cleaning an exposed mesial or distal surface of a tooth or tooth prosthesis comprising: an elongate member comprising a forward end and a backward end, wherein the elongate member comprises a handle portion and the elongate member extends in a longitudinal direction from the forward end to the backward end; a brush head, wherein the brush head comprises a plurality of tufts provided at a forward and/or a backward surface of the brush head and at least one support memberfor the brush head disposed at the forward end of the elongate member wherein the at least one support member is shaped to support the brush head at a transverse distance from the elongate member, wherein the at least one support member comprises a proximal portion and a distal portion to provide a void between the forward end and the brush head.

### FIELD

The present invention relate to a toothbrush product or device, in particular a toothbrush product for cleaning an exposed mesial or distal surface of a tooth or tooth prosthesis comprising.

### BACKGROUND

Unless otherwise specified, the terms “distal”, “distally”, “mesial” and “mesially” are dental terminology and refer to relative positions within the upper or lower dental arch, that is to say, “distal” and “distally” mean “towards the posterior end of the dental arch”, and that, “mesial” and “mesially” mean “towards the midline at the anterior of the dental arch”. “Coronally” refers to the direction toward the crown of a tooth, as opposed to “apically”, which refers to the direction toward the tip(s) of the root(s) or apex(apices).

Plaque gathers on the surface of a tooth or fixed prosthesis along a compound curve or curves at the gingival margin. Spacing adjacent to the mesial or distal surface of a tooth or prosthesis, for example, after loss or congenital absence of an adjacent tooth, paradoxically, creates a challenge in cleaning this surface. It is this paradox which has allowed the dental profession to believe that the patient should be able to clean the area and why creation of an appropriately structured cleaning aid has not occurred.

In cleaning these surfaces effectively, often the patient cannot see the tooth or the surface in question and must use their spatial awareness, manual dexterity and feedback from tactile sensation from the cleaning action. Up to 90% of patients presenting with at least one example of the surface described have plaque remaining there after brushing and cleaning their teeth. Gingival disease and caries often occur due to the ensuing chronic stagnation of plaque in this type of site.

Due to patients’ tendencies to maintain rigidity in the wrist and fingers during tooth cleaning, the arm is usually employed to create the oscillating or reciprocating cleaning action. Due to the length of the arm, this translates to an almost linear action 28 (of FIG. 3) in the oral cavity. This is problematic when trying to clean along the small compound curves of any single tooth which could be anywhere on the upper or lower jaws.

Toothbrushes in the prior art do not adequately translate the said instinctive cleaning motions of people’s arms, hands and fingers into repeatable and effective motions of the brush head and bristles precisely at the said tooth surfaces and the plaque thereon while overcoming the complex curvature and positioning of individual teeth and gingivae.

In many current brushes, their shapes and bristle arrangements mean that overly deliberate and skilled manipulation by the fingertips and wrist is required to effectively clean. In addition, the handles and shafts which support the brush heads and allow them to reach a tooth, are not relatively positioned to one another or shaped appropriately to allow the bristle tips to reach the plaque located specifically as described in the problem. They are impeded by adjacent teeth, opposing teeth, the tooth being cleaned, and the surrounding soft tissues such as tongue or cheek. For example, prior art DE20201800611 OU1 (2nd February, 2018) aims to address the challenge of cleaning these sites. However, it is greatly limited by its structure having the brush head directly attached to the end of its handle. Ultimately, this greatly reduces the quality of the position of its bristle tips while in use.

Many other brushes also encourage a grip by the user which places them at angles which make it awkward to apply effective cleaning motions at the said problem sites. Furthermore, the handle should be of a structure which encourages grip by fingers and fingertips and not the whole hand in order to allow gentle handling and minimise overloading of the brush head and bristles at these delicate sites. Gentle handling also improves tactile feedback to the user.

Many patients and dentists advocate the use of one of the many flexible interdental brushes available, for example EP1862090B1 (May 30th, 2006), to access the surfaces discussed. This is inconvenient as the patient must skilfully bend it into the specific required shape. Also, the brush elements do not maintain the shape and must be bent again which is inconvenient. This repeated deformation also leads to fatigue and softening or breakage of the brush element.

Even when the interdental brush is initially resisting deformation, the nature of their flexibility and that they are mounted to their handle at one end only, means that there is poor quality tactile feedback. Patients are therefore quickly discouraged as they cannot sense their control of the brush they are being advised to use.

In addition, some brushes in the prior art present the bristle tips to the surfaces discussed here at very inefficient angles, for example US8918946B2 (February 13th, 2012), and require prohibitively high levels of manual dexterity. This prior art is also configured for use only at the distal surfaces of molar teeth despite the problem being more widespread.

Some of the prior art consist of structures which put the oral tissues at risk through their continued use or following the wearing out of the bristle elements, for example in the use of prior art DE202010016567U1 (December 12th, 2010) which includes a basic wire brush element. Even before wearing out, this device allows excessive forces to be applied to the gingiva in normal use.

Teeth with the loss of an adjacent tooth at their mesial or distal aspect have a tendency to drift and tip into the space created. This puts their respective surface into an even more awkward position for cleaning. The bristle arrangement, brush head shape and overall structure of the cleaning aid all must contribute to the ability of the bristle tips to reach it.

Patients are wary of hard materials like metals and plastic striking their teeth and gingivae during cleaning. A cleaning aid should ideally be shaped and consisting of certain materials so that if teeth are struck, it is with a pleasant enough sensation to impart confidence and that it causes no trauma to those tissues.

In summary, there is a need for an oral hygiene aid for the general public for consistent effective cleaning of the mesial and/or distal surface and along the compound curve or curves at the gingival margin of a tooth or fixed prosthesis positioned adjacent to a space anywhere in the dental arch. In the prior art there are only very few brushes aimed at this purpose, and not one of them overcomes all of the obstacles nor achieves all the requirements aforementioned.

### SUMMARY

According to a first aspect, there is provided a toothbrush product for cleaning an exposed mesial or distal surface of a tooth or tooth prosthesis comprising:
an elongate member comprising a forward end and a backward end, wherein the elongate member comprises a handle portion and the elongate member comprises a length in a longitudinal direction from the forward end to the backward end;
a brush head, wherein the brush head comprises a plurality of tufts provided at a forward and/or a backward surface of the brush head and at least one support member for the brush head disposed at the forward end of the elongate member wherein the at least one support member is shaped to support the brush head at a transverse distance from the elongate member, wherein the at least one support member comprises a proximal portion extending laterally and a distal portion extending transversely thereby to provide a void between the forward end of the elongate member and the brush head across said transverse distance and wherein at least part of the support member extends away from the forward end of the elongate member in the transverse direction such that the void is provided in a substantially transverse plane.

The at least one support member that provides the brush head at a transverse distance from the handle portion and the void in a transverse plane between the forward end of the elongate member and the brush head may allow a user to easily manipulate the toothbrush product to position the plurality of tufts at the exposed mesial or distal surface of the tooth or tooth prosthesis in an oral cavity and may allow the user to move the plurality of tufts of the brush head along the exposed mesial or distal surfaces while minimizing contact of the toothbrush product with other parts of the oral cavity.

In use, at least part of the toothbrush product may be provided in said oral cavity and the plurality of tufts are provided at said exposed mesial or distal surface of the tooth or tooth prosthesis. In use, the toothbrush product may be placed in a cleaning position in the oral cavity such that the tufts of the brush head are in contact with a mesial or distal surface of the tooth or tooth prosthesis. In the cleaning position, the transverse distance is along an inferior-superior axis. In the cleaning position the transverse distance is substantially parallel to a coronoapical axis e.g. parallel to the long axis of the tooth or tooth prosthesis being cleaned. In the cleaning position at least part of the tooth or tooth prosthesis being cleaned may be present in the void.

The brush head, the at least one support member and the plurality of tufts may be referred to as a brush head assembly.

The at least one support member and brush head may comprise a hook or a loop profile. In use, the hook or loop profile of the at least one support member may allow the support member to be placed around the tooth thereby allowing a user to provide the brush head in a gap adjacent to the tooth or tooth prosthesis to be cleaned.

The at least one support member may be dependent from the elongate member and comprises an overhanging profile. The overhanging profile may allow the support member to provide the brush head at the root of the tooth or tooth prosthesis.

The toothbrush product may comprise a shoulder coupling between the elongate member and the at least one support member.

The shoulder coupling may allow the handle portion to be maintained substantially horizontally, in use, while providing the brush head at the exposed surface of the tooth or tooth prosthesis.

The shoulder coupling may comprise at least one of: a hinge joint, a dovetail joint, a pivot latch joint.

The shoulder coupling may comprise a rotatable coupling allowing the at least one support member to be rotated relative to the elongate member. A user may be able to rotate or swing the at least one support member to varying degrees relative to the elongate member. This may serve the purpose of cleaning mesial and distal surfaces.

The shoulder coupling may couple the elongate portion and the at least one support member such that the at least one support member is projected from the elongate member in a transverse direction at an angle in the range between 15 degrees and 250 degrees. The angle may preferably be in a range between 80 and 120 degrees.

By providing a shoulder coupling that projects the at least one support member at an angle in this angle range, contact between the teeth and the toothbrush product which does not contribute to cleaning may be minimized. In the cleaning position the elongate member sits at a first distance from the upper surface of the tooth and the coupling shoulder projects from the at least one support member laterally and transversely such that the at least one support member may sit at a minimum distance from the surface of the tooth during cleaning.

The at least one support member may comprise a curved profile in the lateral direction and/or a curved profile in the transverse direction.

By providing a curved profile in both or at least one of the lateral direction and the transverse direction, the shape of the support member may be substantially conform or mirror the shape of a typical tooth or tooth prosthesis to be cleaned thereby a minimum distance between the tooth and the toothbrush product can be maintained during use.

The curved profile in the transverse direction and in the lateral direction may be selected to correspond to a curved profile of a tooth or tooth prosthesis.

The at least one support member may comprise a compound curve in the lateral and/or transverse direction. The at least one support member comprises one or more curved portions, wherein each curved portion has a variable radius of curvature along its length.

The at least one support member may comprise an intermediate portion between the proximal portion and the distal portion, wherein the proximal portion is characterised by a first curve, the intermediate portion is characterised by a second curve and the distal portion is characterised by a third curve. The first, second and third curves may form a continuous curve.

The distal portion of the at least one support member may curve either towards or away from the handle portion. In use, the distal portion may curve either towards or away from the handle portion thereby to provide the tufts of bristles closer to the distal or mesial surface of the exposed tooth or tooth prosthesis, respectively.

The at least one support member may comprise a first support member and a second support member disposed on opposing sides of the elongate member and wherein the brush head spans the distance between distal portions of the first and second support members such that at least part of the elongate member, the brush head and the first and second support members form a closed loop.

The support members may be shaped such that the aperture forms a closed loop having a tooth shaped profile.

The first and second support members may be provided in a bifurcated arrangement.

The first and second support members may comprise proximal portions in a lateral direction that are substantially parallel. The first support member may have a proximal portion at its proximal end that extends in a substantially lateral direction and the second support member may have a proximal portion at its proximal end that extends in an opposing lateral direction to the first proximal portion. The first support member may have a distal portion at its distal end that extends in a transverse direction and the second support member may have a distal portion at its distal end that extends in the transverse direction. The distal portion of the first support member and the distal portion of the second support member may be substantially parallel. The brush head may span the distance between the distal ends of the first and second support members. A part, for example, a terminating part of the distal portion of the first support member and a part of the second support member may extend towards the brush head.

The first and second support members, the brush head and at least part of the forward portion of the elongate member may form an aperture. The aperture may be sized such that, in use, at least part of a tooth or tooth prosthesis is able to pass through thereby permitting placement of at least some of the plurality of tufts at a root of the exposed tooth and along the exposed surface of the tooth or tooth prosthesis.

The at least one support member may be substantially flat or may have a square or may have a round cross-section. The at least one support member may have a length in the range 5 to 80 mm. The at least one support member may have a length in the lateral direction in the range 2.5 mm to 25 mm. The at least one support member may have a length in the transverse direction in the range 5 mm to 80 mm. The at least one support member may have an extension in the transverse direction in the range 8 mm to 40 mm.

In the toothbrush product with only one support member, the only one support member may support the brush head in a cantilever arrangement.

The elongate member may comprise a forward portion disposed between the handle portion and the support member wherein the forward portion is inclined and/or curved relative to the handle portion.

By providing an elongate member with a forward portion and/or curved relative to the handle portion, the support member may be positioned, in use, at a position closer to the upper surface of the exposed tooth thereby allowing a more precise placement of the brush head.

The forward portion may be non-curved. The forward portion may be curved towards the brush head. The elongate member may comprise a forward portion disposed forward of the handle portion, coupling the handle portion to the support member. The forward portion of the elongate member may comprise a curve from the handle axis towards the support member. The forward portion may be curved away from the brush head.

The at least one support member may be coupled directed to the forward end of the handle portion.

The brush head may extend laterally from the distal end of the support member and may have a profile that is at least one of a: curved, concave, convex, tear-drop, arched, flat, straight.

The brush may have a profile that comprises a void at a lower or upper side edge. The plurality of tufts may be arranged such that the free ends of the tufts comprise a curved and/or an inclined and/or a vertical side profile.

The tufts may have the same lengths. The tufts may have a distribution of different lengths.

By providing the free ends of the tufts are provided in a curved and/or inclined and/or vertical side profile, the free ends of the tufts may mirror the shape of the exposed surface of the exposed tooth.

The plurality of tufts may be arranged such that tufts provided towards the centre of the brush head are smaller in length relative to tufts provided at either end of the brush head.

The plurality of tufts may be arranged such that the tufts at the most transverse part of the brush head extend further from the brush head surface than tufts provided at the least transverse part of the brush head.

The arrangements of tufts of the brush head may offer advantages in placement of bristles towards at the exposed surface. For example, the tufts may be arranged to mirror the shape of the surface of the tooth. In use, the tufts that extend furthest from the brush head may be provided at the root of the tooth or tooth prosthesis. The tufts may be replaceable. The tufts may comprise elastomer bristles. The tufts may comprise a material with antimicrobial or plaque repellent properties.

The brush head may comprise a longest dimension, referred to as the width, in the range of 5 to 50 mm. The plurality of tufts may comprise bristles having a length in the range 1 to 15 mm. The plurality of tufts may comprise tufts arranged in rows of substantially the same length. The rows may be arranged in length order.

The toothbrush product may comprise a first plurality of tufts on the forward surface of the brush head and a second plurality of tufts on the backward surface of the brush head.

The first plurality of tufts may be aligned along a first tuft axis and the second plurality of tufts may be aligned along a second tuft axis. The angle between the first tuft axis and the second tuft axis may be in the range from 30 degrees to 280 degrees, preferably in the range 90 to 180 degrees.

The handle portion may comprise one or more gripping features.

The one or more gripping features may comprise at least one of:
a) depressions for receiving fingertips;
b) a non-circular cross-section, for example, a flat, flat-elliptical or triangular, curved cross-section;
c) a variable cross section along the length of the handle portion;
d) a height and a width, wherein the height is greater than the width for at least part of the handle portion, wherein the height is substantially perpendicular to the length of the handle portion and/or the brush head
e) a circular cross section.

The brush head may be a first brush head and the toothbrush product may further comprise a second brush head disposed at a backward end of the elongate member, wherein the first brush head comprises a first plurality of tufts oriented substantially in one of the forward and/or backward directions and the second brush head comprises a plurality of tufts oriented substantially along the other of the forward and backward directions. A handle portion may be provided between the first brush head and the second brush head.

The elongate member may comprise a forward portion curved towards the first brush head and a backward portion curved towards the second brush head, wherein the handle portion is provided between the forward and backward portions.

The elongate member may comprise a forward portion curved towards or away from the first brush head and the elongate member may comprise a forward portion curved towards or away from the second brush head, wherein the handle portion is provided between the forward and backward portions.

The toothbrush product having two brush heads and/or more than one plurality of tufts may allow for both mesial and distal cleaning without removing the toothbrush product from the mouth.

The handle portion of the elongate member may be provided along a handle axis. The forward portion of the elongate member may be substantially provided along a forward axis. A support member axis may be defined by a straight line between a first coupling of the support member to the elongate me mber and a second coupling between the support member and the brush head. The plurality of tufts may be aligned along a tuft axis. The brush head may comprise a length that is substantially aligned along a brush head axis.

The angle between the handle axis and the forward axis may be in the range 70 to 270 degrees, preferably in the range 160 and 200 degrees.

The angle between the handle axis and the support member axis may be in the range 30 to 150 degrees, preferably in the range 70 to 110 degrees.

The angle between the forward axis and the support member axis may be in the range 15 to 250 degrees, preferably between 80 and 120 degrees.

The angle between the support member axis and the tuft axis may be in the range 40 to 320 degrees, preferably in the range 90 and 130 degrees.

The angle between the handle axis and the brush head axis may be in the range 0 to 90 degrees.

The brush head and/or plurality of tufts may be reversible detachable and/or separable from the toothbrush product. A brush head and/or tuft coupling mechanism may be provided to couple the brush head and/or plurality of tufts to the toothbrush product. The brush head coupling may comprise at least part of the at least one support member. The brush head coupling may comprise at least one mating feature configured to mate with a corresponding feature of the at least one support member.

The elongate member and/or the brush head and/or the at least one support member may be manufactured out of at least one of: a biodegradable material, plastic, bamboo, an elastomer, elastomer coated.

The bristles of the plurality of tufts may comprise any suitable material, for example, elastomer and/or nylon.

According to a second aspect, there is provided a brush head assembly configured to be coupled to an elongate member comprising a handle portion, wherein the brush head assembly comprises:

a brush head comprising a plurality of tufts provided at a forward and/or a backward surface of the brush head and at least one support member for the brush head and a brush head assembly coupling for coupling the at least one support member to an elongate member comprising a handle portion, wherein the at least one support member is shaped to provide the brush head at a distance from the brush head assembly coupling and wherein the at least one support member comprises a proximal portion extending laterally and a distal portion extending transversely from the brush head assembly coupling, such that a void is provided between the brush head assembly coupling and the brush head across said distance.

The brush head assembly coupling may provide a coupling between the support member and the elongate member such that, at least part of the support member extends away from the forward end of the elongate member in the transverse direction such that the void is provided in a substantially transverse plane.

The brush head assembly may be for an electric toothbrush. The brush head assembly may be configured to be coupled to an electric toothbrush.

The brush head assembly may be coupled directly to an electric toothbrush body. The brush head assembly coupling may comprise a recess configured to be fitted to a corresponding coupling portion of the electric toothbrush body. The brush head assembly may be provided at a distal end of an elongate member and the elongate member may be configured to couple to an electric toothbrush body at the proximal end of the elongate member.

The brush head assembly may be coupled indirectly to the electric toothbrush body, via a further member. The further member may comprise a recess configured to be fitted to a corresponding coupling portion of the electric toothbrush body.

The coupling member may be a shaft extending from the electric toothbrush body. The coupling member may be a moveable member. The coupling member may be a vibrating member. The coupling member may cause the brush head assembly to vibrate or oscillate, in use.

The brush head assembly may be coupled to an elongate member, for example, an elongate member comprising a handle portion.

According to a third aspect, there is provided a kit of parts comprising:

the brush head assembly according to the second aspect and the elongate member.

The brush head assembly may comprise a first mating feature at the brush head assembly coupling and the elongate member may comprise a second corresponding mating feature configured to mate to the first mating feature. The second corresponding mating feature is provided at the forward end of the elongate member.

The brush head assembly coupling between the brush head assembly and the elongate member may comprise an adjustable coupling permitting adjustment of the transverse and/or longitudinal distance of the brush head relative to the handle portion.

The adjustable coupling is formed by the elongate member having may a curved forward portion that curves away from the handle portion wherein the at least one support member is configured to be coupled at a number of attachment points along said curved portion such that the longitudinal distance and transverse distance between the elongate member and the brush head may be adjusted by changing the attachment point of the at least one support member to the curved forward portion.

The coupling between the brush head assembly and the elongate member may comprise a coupling mechanism, wherein the coupling mechanism may be a reversibly detachable coupling mechanism. The coupling mechanism may comprise a latch. The coupling mechanism may be operable to be clicked into a coupling position. The coupling between the brush head assembly and the elongate member may be a permanent coupling.

According to a fourth aspect there is provided a brush head assembly for a toothbrush device, wherein the brush head assembly is configured to be coupled to a forward end of an elongate member comprising a handle, and wherein the brush head assembly comprises:
a brush head member comprising a forward surface and a backward surface, wherein the forward surface faces a forward direction and the backward surface faces a backward direction;
a plurality of tufts provided on at least one of the forward surface and the backward surface;
a support member configured to support the brush head, wherein the support member comprises a coupling at a first end for coupling to the forward portion of the elongate member and comprises a portion that extends transversely from the coupling so that the brush head is supported at a transverse distance from the coupling and wherein at least part of the support member extends in at least one of the forward or backward directions such that at least one of a) and b):
   a) the forward surface of the supported brush head is provided forward of the coupling;
   b) the backward surface of the supported brush head is provided backward of the coupling.

The support member may define a support member plane. The support member plane may be substantially parallel to a transverse plane. The forward surface of the supported brush head may be provided at a forward position relative to the coupling. The backward surface may be provided at a backward position relative to the coupling.

The brush head member may have a longest dimension spanning a lateral direction relative to to the transverse distance. The longest dimension of the brush head member may be normal to the support member plane. The forward/backward directions may be substantially parallel and may define a forward-backward axis. The forward- backward axis may lie in the support member plane.

The plurality of tufts may be aligned along one or more tuft axes, for example, the plurality of tufts of the forward surface may be aligned along a forward tuft axis and the plurality of tufts of the backward surface may be aligned along a backward tuft axis. The forward and backward tuft axes may aligned such that angle is provided therebetween or may be substantially parallel.

The plurality of tufts may be provided at an angle relative to the forward/backward regions.

The forward/backward direction may define at least one tuft axis. The brush head may span along a lateral axis. The support member may extend along a transverse axis.

The support member may be coupled to the brush head substantially at a middle region of the longest dimension of the brush head.

The support member may be curved or inclined in the forward direction. The support member portion may be curved or inclined in the backward direction.

In use and when assembled together with the elongate member to form a toothbrush device, the brush head assembly may be provided in the oral cavity and the plurality of tufts are provided at said exposed mesial or distal surface of the tooth or tooth prosthesis. In use, the toothbrush device may be placed in a cleaning position in the oral cavity such that the tufts of the brush head are in contact with a mesial or distal surface of the tooth or tooth prosthesis. In the cleaning position, the transverse distance is along an inferior-superior axis. In the cleaning position the transverse distance is substantially parallel to a coronoapical axis e.g. parallel to the long axis of the tooth or tooth prosthesis being cleaned.

The plurality of tufts may be provided substantially as described in accordance with the first aspect. The plurality of tufts may be arranged such that the free ends of the tufts comprise a curved and/or inclined and/or vertical side profile. The forward and/or backward surface may comprise a curved and/or inclined and/or vertical side profile. The plurality of tufts may be arranged such that the free ends of the tufts comprise a curved and/or an inclined and/or a vertical side profile.

By providing the free ends of the tufts are provided in a curved and/or inclined and/or vertical side profile, the free ends of the tufts may mirror the shape of the exposed surface of the exposed tooth.

The plurality of tufts may be arranged such that tufts provided towards the centre of the brush head are smaller in length relative to tufts provided at either end of the brush head.

The plurality of tufts may be arranged such that the tufts at the most transverse part of the brush head extend further from the brush head surface than tufts provided at the least transverse part of the brush head.

The arrangements of tufts of the brush head may offer advantages in placement of bristles towards at the exposed surface. For example, the tufts may be arranged to mirror the shape of the surface of the tooth. In use, the tufts that extend furthest from the brush head may be provided at the root of the tooth or tooth prosthesis.

The tufts may be replaceable. The tufts may comprise elastomer bristles. The tufts may comprise a material with antimicrobial or plaque repellent properties.

The brush head may comprise a longest dimension, referred to as the width, in the range of 5 to 50 mm. The plurality of tufts may comprise bristles having a length in the range 1 to 15 mm. The plurality of tufts may comprise tufts arranged in rows of substantially the same length. The rows may be arranged in length order.

The toothbrush product may comprise a first plurality of tufts on the forward surface of the brush head and a second plurality of tufts on the backward surface of the brush head.

The brush head assembly may be for an electric toothbrush. The brush head assembly may be configured to be coupled to an electric toothbrush.

The brush head assembly may be coupled directly to an electric toothbrush body. The brush head assembly coupling may comprise a recess configured to be fitted to a corresponding coupling portion of the electric toothbrush body. The brush head assembly may be provided at a distal end of an elongate member and the elongate member may be configured to couple to an electric toothbrush body at the proximal end of the elongate member.

The brush head assembly may be coupled indirectly to the electric toothbrush body, via a further member. The further member may comprise a recess configured to be fitted to a corresponding coupling portion of the electric toothbrush body.

The coupling member may be a shaft extending from the electric toothbrush body. The coupling member may be a moveable member. The coupling member may be a vibrating member. The coupling member may cause the brush head assembly to vibrate or oscillate, in use.

The brush head assembly may be coupled to an elongate member, for example, an elongate member comprising a handle portion.

According to a fifth aspect there is provided a toothbrush device for cleaning an exposed mesial or distal surface of a tooth or tooth prosthesis comprising:
an elongate member comprising a forward end and a backward end, wherein the elongate member comprises a handle portion and the elongate member comprises a length in a longitudinal direction from the forward end to the backward end;
a brush head member comprising a forward surface and a backward surface, wherein the forward and backward surfaces face in forward and backward directions, respectively,
a plurality of tufts provided on at least one of the forward surface and the backward surface;
a support member configured to support the brush head, wherein the support member is coupled at a first end to the forward portion of the elongate member and comprises a portion that extends transversely from the forward end of the elongate member so that the brush head is supported at a transverse distance from the forward end of the elongate member and wherein at least part of the support member extends in at least one of the forward or backward directions such that at least one of a) and b):
   a) the forward surface of the supported brush head is provided forward of the forward end of the elongate member;
   b) the backward surface of the supported brush head is provided backward of the forward end of the elongate member.

According to a sixth aspect, there is provided a kit of parts comprising the brush head assembly in accordance with the fourth aspect and the elongate member comprising a handle.

Any feature in one aspect may be applied to other aspects, in any appropriate combination. For example, features of the toothbrush product of the first aspect or fifth aspect may be provided as features of the brush head assembly of the second and fourth aspect and vice versa. For example, features of the toothbrush product of the first aspect may be provided as features of the toothbrush product of the fifth aspect and vice versa. For example, features of the brush head assembly of the second aspect may be provided as features of the brush head assembly of the fourth aspect, and vice versa.

### BRIEF DESCRIPTION OF THE DRAWINGS

Various aspects of the invention will now be described by way of example only, and with reference to the accompanying drawings, of which:

FIGS. ’s1A-1E are front, left and right elevational, and top and bottom plan views of an embodiment of the device which enables the user to clean mesial tooth surfaces

FIG. 1F shows the cross-section of one example of a brush head

FIG. 1G is a top plan view of an embodiment of the device while in use to clean a mesial tooth surface

FIG. 1H is a right elevational view of an embodiment of the device while in use to clean a mesial tooth surface

FIG. 1I is a right elevational view of an embodiment of the device while in use to clean a mesial surface of a tipped tooth which has suffered periodontal recession

FIG. 2 shows the typical directions of a user’s forces which seat cleaning devices being used for the mesial or distal aspects of teeth

FIG. 3 shows the typical cleaning motion which oscillates buccally and lingually employed with a device being used for the cleaning of mesial or distal aspects of teeth

FIGS. ’s4A-4E are front, left and right elevational, and top and bottom plan views of an embodiment of the device which enables the user to clean distal tooth surfaces

FIG. 4F is a top plan view of an embodiment of the device while in use to clean a distal tooth surface

FIG. 4G is a right elevational view of an embodiment of the device while in use to clean a distal tooth surface

FIG. 5A is a perspective view of an embodiment of the device which allows the user to clean both mesial and distal surfaces of teeth

FIG. 5B is a top plan view of an embodiment of the device which allows the user to clean both mesial and distal surfaces of teeth

FIG. 5C is right elevational view of an embodiment of the device which allows the user to clean both mesial and distal surfaces of teeth

FIG. 6A is right elevational view of an embodiment of the device which allows the user to clean both mesial and distal surfaces of teeth

FIG. 6B is a bottom plan view of an embodiment of the device which allows the user to clean both mesial and distal surfaces of teeth

FIG. 6C shows the cross-sectional view of the brush head of an embodiment of the device which allows the user to clean both mesial and distal surfaces of teeth

FIG. 6D is a front elevational view of an embodiment of the device which allows the user to clean both mesial and distal surfaces of teeth and incorporates a brush head shaped in the form of a single curve

FIG. 6E is a front elevational view of an embodiment of the device which allows the user to clean both mesial and distal surfaces of teeth and incorporates a brush head shaped in the form of two flat areas at the ends of the head and an area shaped with compound curves in the centre

FIG. 7 is a front elevational view of an embodiment of the device which allows the user to clean mesial surfaces of teeth and incorporates a brush head shaped in the form of a single curve

FIG. 8 is a front elevational view of an embodiment of the device which allows the user to clean mesial surfaces of teeth and incorporates a brush head shaped in the form of two flat areas at the ends of the head and an area shaped with compound curves in the centre

FIG. 9 is a front elevational view of an embodiment of the device which allows the user to clean mesial surfaces of teeth and incorporates a straight-edged brush head with bristles arranged along a straight edge

FIG. 10 is a front elevational view of an embodiment of the device which allows the user to clean mesial surfaces of teeth and incorporates a straight-edged brush head with bristle tips arranged along a compound curve in the centre region and along a straight edge at the ends

FIG. 11 shows the relative angles between components in an embodiment of the device which allows the user to clean mesial surfaces of teeth

FIG. 12 shows the functional curves within the forms of the secondary members

FIGS. ’s. 13A-13D show front and right elevational views of the separate handle and brush head assembly of an embodiment of the device which allows the user to clean mesial or distal surfaces of teeth and incorporates a brush head shaped in the form of two flat areas at the ends of the head and an area shaped with compound curves in the centre

FIG. 13E shows the components in FIGS. ’s. 13A-13D joined to form an embodiment of the device which allows the user to clean mesial surfaces of teeth

FIG. 13F shows the components in FIGS. ’s. 13A-13D joined to form an embodiment of the device which allows the user to clean distal surfaces of teeth

FIGS. 14A to C show a toothbrush device having a single support member and a plurality of tufts provided on a forward surface of a brush head member, in accordance with a further embodiment

FIGS. 15A to C show a toothbrush device having a single support member and a plurality of tufts provided on a backward surface of a brush head member, in accordance with a further embodiment

FIGS. 16A to C show a toothbrush device having a single support member and a first plurality of tufts provided on a forward surface of a brush head member and a second plurality of tufts provided on a backward surface of the brush head member, in accordance with a further embodiment

### DETAILED DESCRIPTION OF THE DRAWINGS

The device described in the following may allow the user to overcome the common difficulties in plaque removal from the mesial or distal surfaces of teeth or fixed prostheses which lie adjacent to spacing within the dental arch. The device may obviate the need for high manual dexterity and overcomes other limitations encountered when using devices in the prior art for this purpose.

Due to patients’ tendencies to maintain rigidity in the wrist and fingers during tooth cleaning, the arm is usually employed to create the oscillating or reciprocating cleaning action. Due to the length of the arm, this translates to an almost linear action 28 (of FIG. 3) in the oral cavity. This is problematic when trying to clean along the small compound curves of any single tooth which could be anywhere on the upper or lower jaws.

The user’s linear action which oscillates between the buccal and lingual aspects of the tooth FIG. 3 is very reproducible and ideally should translate into effective cleaning due to the merits of the toothbrush structure. The most reproducible force which seats and places the brush in the required position 27 for solving the problem is directed into the junction between the tooth and gingiva at the mesial or distal aspect and the toothbrush structure should allow the user to make efficient use of it to maintain the brush head’s appropriate position. The toothbrush should also offer tactile feedback to the user throughout the cleaning motions to confirm and reinforce the correctness of their technique. This will develop a reproducible and effective technique.

In the following various embodiments of a toothbrush product are described. A handle 20 is shaped to allow fingers to resist the adverse torqueing moment around its longitudinal axis generated by friction while the device is in use thereby maintaining its optimal orientation, for example, and not limited to, as depicted in FIGS. ’s1A-13F. In some embodiments, the handle has dimensions which help prevent excessive application of grip and strength by the user.

In preferred embodiments, at its distal end, the handle 20 merges with a first member 22 which may be straight or curved. The first member 22 and the handle 20 may also form a single elongate member that has a forward end and a backward end. The first member 22 may be referred to as forward portion of the elongate member and the handle 20 may be referred to as a handle portion of the elongate member. The elongate member extends in a longitudinal direction from the forward end to the backward end such that the elongate member has a length in the longitudinal direction. In preferred embodiments, at the distal end of the first member 22 may be two additional bifurcating secondary members 40. The secondary members 40 may also be referred to as support members. The secondary member 40 provide support for the brush head. The secondary members 40 are disposed or provided at the forward end of the elongate member i.e. the secondary members 40 are provided at the end of the first member 22.

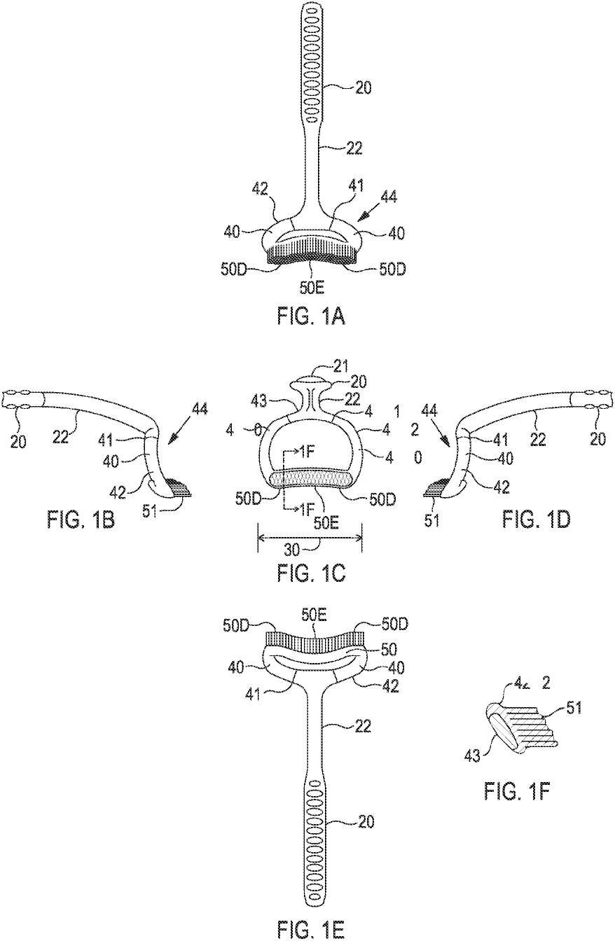

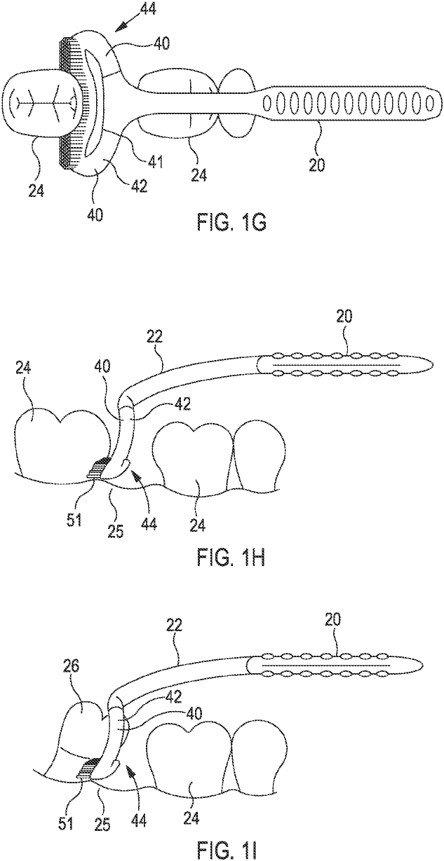

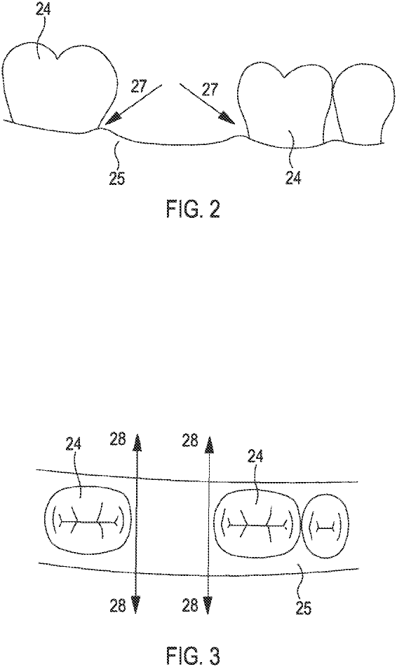

In preferred embodiments, the secondary members 40 serve to support a brush head 50 which spans their distal ends. The secondary members 40 are provided at the forward end of the first member 22 and are shaped to support the brush head 50 at a transverse distance from the first member 22. As depicted in FIG. 1, the brush head 50 is supported at a transverse distance from the forward end of the elongate member i.e. in a direction that is considered substantially perpendicular or normal to the longitudinal direction of the elongate member. The secondary members 22 are provided at opposing sides of the elongate member and are provided in a substantially parallel arrangement.

In use, when the toothbrush is provided at a cleaning position, the transverse distance is along an inferior-superior axis of the mouth. In the cleaning position the transverse distance is substantially parallel to a coronoapical axis e.g. parallel to the long axis of the tooth or tooth prosthesis being cleaned. In the cleaning position at least part of the tooth or tooth prosthesis being cleaned may be present in the void.

In some embodiments, each of the pair of secondary members 40 mirror each other. A first secondary member of the pair is described in the following, with the understanding the second secondary member of the pair mirrors the shape of the first secondary member. The first of the pair of secondary members 40 has a proximal portion that extends laterally from the first member 22. In the present embodiment, the lateral direction is substantially lateral to the longitudinal direction of the elongate member and substantially lateral to the transverse distance between the first member 22 and the brush head 50. The lateral direction may also be considered as lateral to the plane in which the elongate member lies in. Viewing the toothbrush product from the front profile, for example as depicted in FIG. 1C, the proximal portions of the secondary members 40 extend outwardly to either side (left and right) of a central part formed by the elongate member.

Each of the secondary members 40 also has a distal portion that extends transversely across the transverse distance between the brush head 50 and the first member 22.

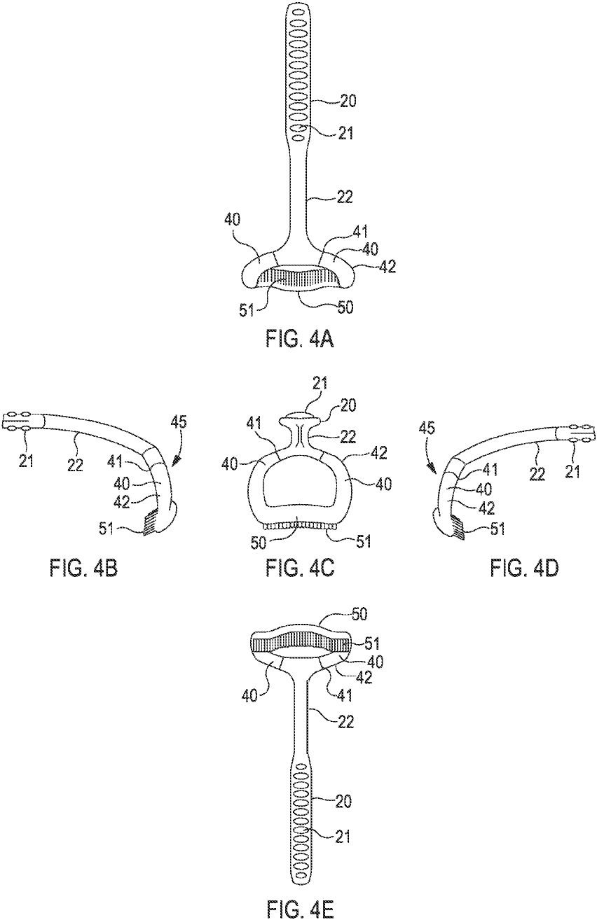

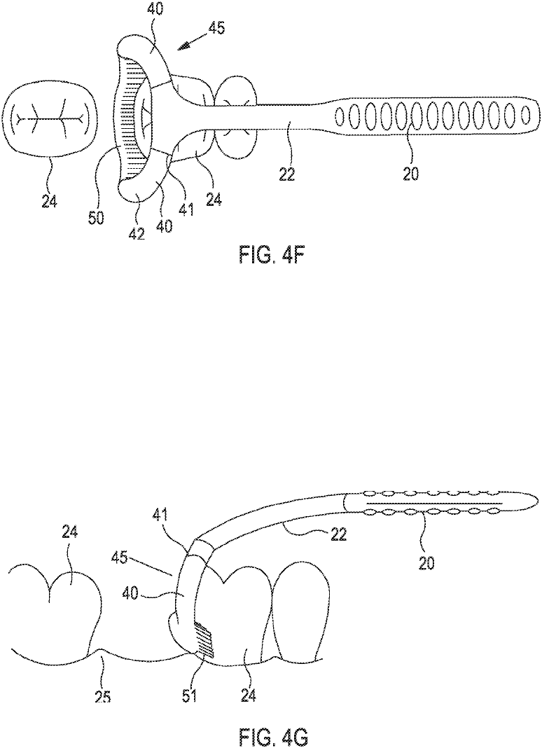

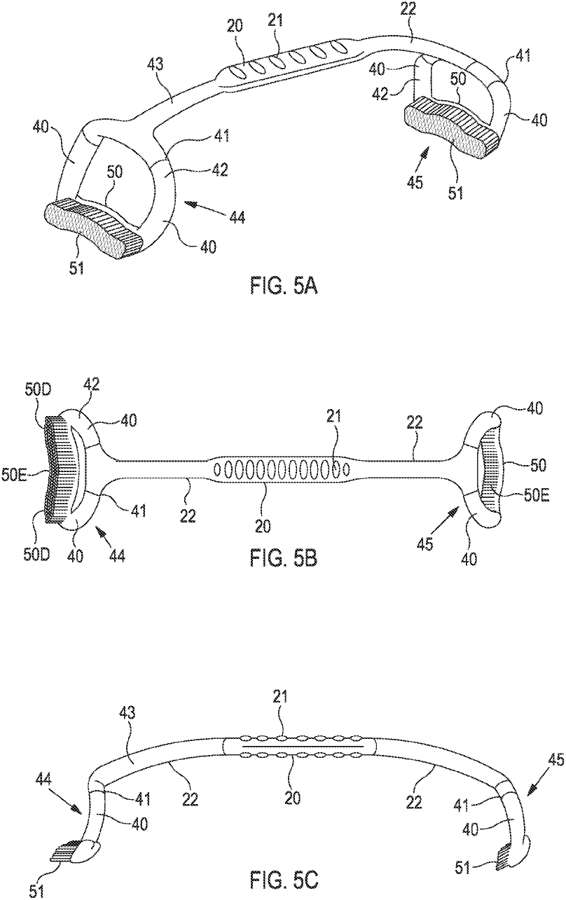

The distal portion of the secondary member 40 depends from the proximal portion of the secondary member 40 i.e. extends in a downward direction. The proximal portion ensures that the distal portion is provided at a lateral distance from the first member 22 and centre of the brush head 50. As may be seen, for example, from FIG. 4D, the secondary members 40 are dependent from the first member 22 and form an overhanging profile. The overhanging profile may allow the support member to provide the brush head at the root of the tooth or tooth prosthesis.

As depicted in, for example, FIG. 1D, in some embodiments, the distal portion of each of the secondary members 40 curves away from the handle 20 in a generally forward direction. In other embodiments, for example the embodiment depicted in FIG. 4, the distal portion of each of the secondary members 40 curves towards the handle 20 in a generally backward direction.

The brush head 50 spans the distance between the distal portions of the secondary members 40. Together, the secondary members 40, the brush head 50 and at least part of the first member 22 form a closed loop. The closed loop is depicted, for example, in FIG. 1C. The closed loop may have different profiled shapes in different embodiments. For example, the loop may have a tooth shaped profile. The closed loop provides an aperture, through which the at least part of the tooth is able to pass through allow placement of the tufts at the cleaning position.

Between the first member 22 and the secondary member 40 there is a shoulder coupling. The shoulder coupling is shaped to project the secondary members 40 substantially in the transverse direction. In accordance with embodiments, the shoulder coupling may project the secondary member 40 at an angle. In some embodiments, the angle in the range between 15 degrees and 250 degrees. In some embodiments, the angle is between 80 degrees and 120 degrees.

In the embodiment depicted, for example, in FIG. 1, the shoulder coupling is non-detachable, i.e. the secondary members 40 and the first member 22 formed part a single member. In other embodiments, the secondary members 40 and the first member 22 are permanently connected. However, it will be understood that in other embodiments, these parts are detachable from each other. The shoulder coupling this may be any suitable coupling, for example, a hinge joint, a dovetail, a pivot latch joint.

The shoulder coupling may allow the handle portion to be maintained substantially horizontally, in use, while providing the brush head at the exposed surface of the tooth or tooth prosthesis.

The secondary members 40 thereby form a void in a substantially transverse plane. The transverse plane may be considered as a plane in which the secondary members 40 substantially lie in. As the secondary members 40 have a curved profile, it will be understood that the void may lie, mostly in such a plane, however, the void may have a curved profile.

In the present embodiment, as depicted in FIG. 1, the elongate member, in particular the handle 20, is substantially normal or perpendicular to the transverse plane in which the void is provided. It will be understood that substantially normal may be in a direction within a suitable angular range of 90 degrees.

In use, the toothbrush product may be placed in a cleaning position in the oral cavity such that the tufts of the brush head are in contact with a mesial or distal surface of the tooth or tooth prosthesis. In the cleaning position, the transverse distance is along an inferior-superior axis. In the cleaning position the transverse distance is substantially parallel to a coronoapical axis e.g. parallel to the long axis of the tooth or tooth prosthesis being cleaned. In the cleaning position at least part of the tooth or tooth prosthesis being cleaned may be present in the void.

The brush head 50 has bristles 51 mounted thereon. The secondary members 40, the brush head 50 and bristles 51 (plurality of tufts) together may also be referred to as the “brush head assembly”. The brush head assembly may form a detachable component of a toothbrush kit together with the elongate member (the handle and first member).

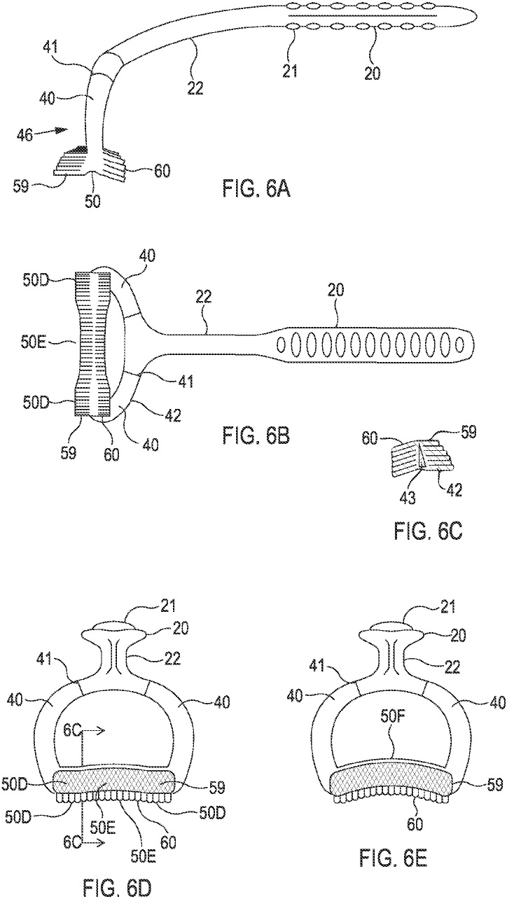

The bristles 51 are provided as a plurality of tufts. The brush head has a first surface that faces a forward direction and a second surface that faces a backward direction that may be referred to as forward and backward surfaces, respectively. In FIG. 1, the plurality of tufts are depicted on the forward surface extending in a generally forward direction, in accordance with embodiments, however, it will be understood that they may be provided on a surface extending in a backward direction (towards the back end of the elongate member) for example, as depicted in FIG. 4. In some embodiments, a first plurality of tufts is provided on the forward surface, extending in a forward direction and a second plurality of tufts may be provided on a backward surface extending in a backward direction. An example of such an embodiment is depicted at FIG. 6A.

By providing a toothbrush product having a void in a transverse plane, defined relative to a longitudinal direction of a handle, the toothbrush may benefit from a number of advantages. In particular, easier manipulation of the toothbrush to place bristles to a desired brushing position at an exposed mesial or distal surface. Relative to the handle 20, the first member 22 is shaped to aid in the application of the brush head 50 to the said tooth surfaces and minimise collision of the device with other teeth during use.

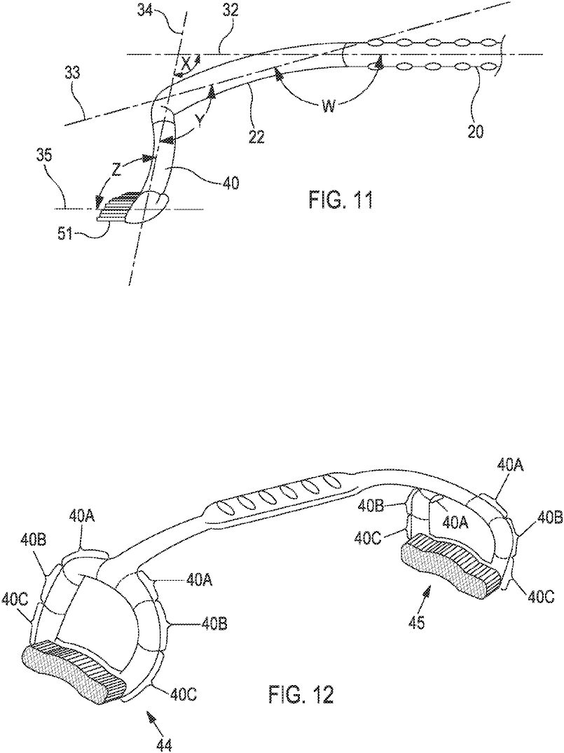

The angle (W) FIG. 11 between the longitudinal axis 32 of the handle 20 (also referred to as a handle axis) and the longitudinal axis 33 of first member 22 (also referred to as a forward axis) may optimise the ability of the brush head assembly to reach the area to be cleaned and may vary from 70 degrees to 290 degrees. In some embodiments, the angle W may be in the range 160 and 200 degrees.

In other embodiments, the brush head assembly may be at the distal end of the handle and without the presence of a first member.

In other embodiments FIGS. ’s1A-1E, 1G-1I, 7-10, the elements of the device may be arranged so that it may be used for the cleaning of mesial tooth surfaces.

In other embodiments FIGS. ’s4A-4G, the elements of the device may be arranged so that it may be used for the cleaning of distal tooth surfaces.

In other embodiments FIGS. ’s5A-5C, the elements of the device may be arranged so that it may be used for the cleaning of either mesial or distal tooth surfaces by way of inclusion of an additional set of all the said parts, features and arrangements, other than the handle, at the proximal end of the handle imparting a double-ended structure to the device.

While the embodiments depicted in the Figures have two secondary members 40, for example, FIG. 1 depicts two secondary members in a bifurcating arrangement, for example, forming a loop profile together with the brush head, it will be understood that in other embodiments, a single secondary member or support member may be provided that is shaped to provide the brush head at a transverse distance from the elongate member. The single support member and the brush head may form a hook profile. The hook profile, like the loop profile, allows the support member to be place around the tooth allowing the brush head to be placed in a gap adjacent to the tooth. The hook profile may be provided in a substantially transverse plane. In some embodiments, the single secondary member may support the brush head in a cantilever arrangement.

The secondary members 40 may have a curved profile in both the lateral and transverse directions. In embodiments FIGS. ’s1, 4-13, the secondary members 40 may have compound curves in their form in order to minimise their collision with teeth during use and to support the brush head 50 in the most effective position possible to fulfil the said purpose as follows. The first portion of each secondary member 40A FIG. 12 is shaped as follows: from its proximal to its distal aspect, it projects mostly laterally. It also curves a little towards the sulcus. The second portion of each secondary member 40B is shaped as follows: from its proximal to its distal aspect, it projects mostly towards the sulcus. It curves and projects laterally away from the tooth a little. It also curves a little distally if it is part of an embodiment primarily for mesial tooth surface use 44 or, a little mesially if it is part of an embodiment primarily for distal tooth surface use 45. The third portion of each secondary member 40C is shaped as follows: from its proximal to its distal aspect it projects mostly towards the sulcus. It curves and projects laterally towards the tooth a little. It also curves a little distally if it is part of an embodiment primarily for mesial tooth surface use 44, or mesially if it is part of an embodiment primarily for distal tooth surface use 45. In some embodiments, the secondary members 40 have more than one curved portion, each portion having a variable radius of curvature.

The angle (Y) FIG. 11 between the longitudinal axis 34 of the second 40B and third 40C sections of the secondary members (also referred to as the support member axis) and the longitudinal axis 33 of first member 22 may optimise the ability of the brush head 50 to reach the area to be cleaned and may vary from 15 degrees to 250 degrees. In some embodiments, the angle Y may be in the range between 80 and 120 degrees. Serving the same purpose, the angle (X) FIG. 11 between the longitudinal axis 34 of the second 40B and third 40C sections of the secondary members (which may also be referred to as the support member axis) and the longitudinal axis 32 of the handle 20 (also referred to as the handle axis) may vary from 30 degrees to 150 degrees. In some embodiments, the angle Xis in the range 70 to 110 degrees.

The longest dimension of the brush head which herein is referred to as the width 30 of the brush head assembly may be from 5 to 50 mm and the length of the secondary members may be from 5 to 80 mm.

Brush head assemblies in various embodiments may be orientated according to their primary use in either for the cleaning of mesial or distal tooth surfaces.

The brush head assembly may have just one secondary member and at its distal end suspend the brush head by one of its ends in a cantilever arrangement.

The secondary members may have any shape required to fulfil the essence of the invention. Their shapes may lie on a flat plane or flat planes. They may be straight or straighter than as depicted in the embodiments showing compound curves in FIGS. ’s1, 5-13. They may have simple curve forms.

The brush head of FIGS. ’s1, 5-13 has bristles FIGS. ’s1, 5-13 mounted thereon. Relative to the secondary members, it is angled to allow very close access to the said tooth surfaces and gingival margins by the bristle tips.

The brush head may be one of any variety of shapes in order to accomplish the essence of the invention, for example as in FIGS. ’s7-10 incorporating curved SOE and/or flat sections 50D. In various embodiments, the brush head may comprise a profile that is: curved, concave, convex, tear-drop, arched, flat, straight. As described above, the brush head forms part of a closed loop. The shape of the loop is therefore dependent on the shape of the brush head.

The brush head may be shaped with compound curves SOE so that in the motions described above, the bristles will be allowed to act as efficiently as possible throughout the linear reciprocating motion of the user 28 and carry the bristles and their tips against the tooth along the gingival margin. In the embodiment depicted in FIG. 8, the middle section SOE curves coronally and mesially if brush head assembly is for mesial tooth surface cleaning 44. The middle section SOE curves coronally and distally if head assembly is for distal surface cleaning 45. Flat end-sections 50D contribute to a smoother motion at the extremities of the reciprocation.

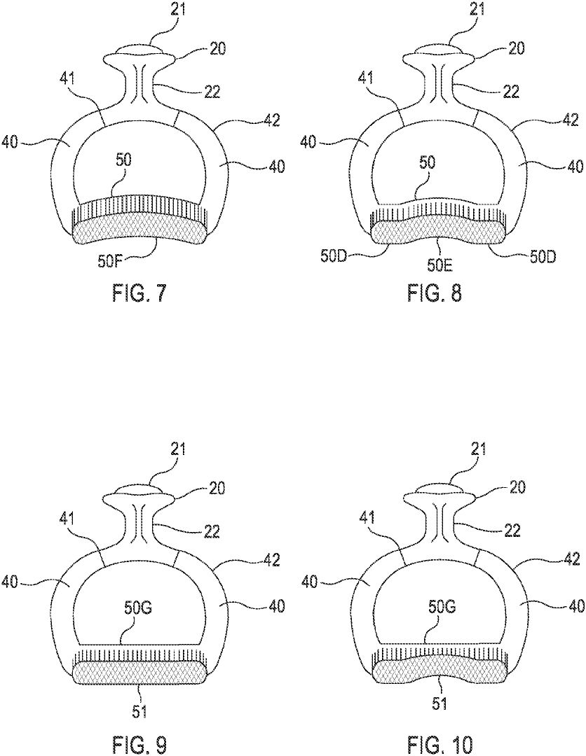

In other embodiments, the brush head may have a single constant curve with equal length bristles FIG. 7, curving coronally and mesially if the brush head assembly is for mesial surface cleaning; and, curving coronally and distally if it is for distal surface cleaning.

Alternatively, the brush head may be straight with bristles of any length or lengths upon it, for example, with their tips in a curved formation.

Alternatively, the brush head may be straight with bristles of equal lengths. Alternatively, the brush head may be straight with bristle tips arranged along a compound curve in the centre region and along a straight edge at its two extremities FIG. 10.

The brush head in preferred embodiments may have a teardrop-shaped cross section 52. This is a compact arrangement which allows the head 50 and bristles 51 to tuck under the overhangs of fillings, fixed prostheses and tipped teeth 26. It also allows an increased strength to the brush head while minimising its bulk in key areas.

A brush head may be double sided enabling it to assist the user in cleaning mesial or distal tooth surfaces FIGS. ’s6A-6E. It may consist of one or two brush heads and two sets of bristles, set back-to-back and mounted at the end of the secondary member or members. Any of the permutations described for any other embodiments herein also apply to any aspect of the embodiment with this dual-purpose brush head.

The bristle bundles 51 may consist of one of any combination of qualities, for example in length, shape, hardness, and being set at various angles upon the brush head 50.

The bristles in the various embodiments may vary in length between 1 mm and 15 mm.

FIG. 6C depicts a first plurality of tufts provided on a first, forward surface of the brush head and a second plurality of tufts provided on a second, backward surface of the brush head. The first plurality of tufts are aligned along a first tuft axis and the second plurality of tufts are aligned along a second tuft axis and the angle between the first tuft axis and the second tuft axis may be in the range from 30 degrees to 280 degrees, and preferably between 90 degrees and 180 degrees.

In preferred embodiments, the bristles may be made of elastomer which has been injection molded over a plastic brush head. Advantages are gained in the use of injection over-molded elastomeric bristles on plastic heads FIGS. ’s1F, 6C instead of nylon bristle tufts embedded in a plastic head. It offers the scope to manufacture a brush head structure which can have a high finesse in its cleaning function at the said sites due to its shape and in the possible positioning of bristles thereon. Elastomeric bristles’ properties can be specified to be very gentle on inflamed gingival tissue and pleasant to use. The structure of this innovative device is so effective at bringing the bristles into direct contact with the delicate gingival margin of a single tooth that the potential abrasion of this tissue must be considered thus.

Further advantages that elastomer molded over plastic offers over common nylon bristle brush head structures are: brush head dimensions can be more compact; in a given set of dimensions of brush head a variety of individual bristle characteristics can be incorporated within very close proximity for example by a variety of bristle lengths, angles or diameters; and, advantages of properties of a carefully specified plastic core can be utilised, for example with a combination of flexibility and firmness without leading to permanent deformation in use; and, also in optimising the distribution of forces generated by the user to the bristles.

In many of the embodiments depicted here, the elastomer has been over-molded not only onto the brush head but also extending along and upon a significant length of the secondary members. This offers a more cushioned and comfortable sensation to the user if the secondary members collide with teeth during use. Extension may also include around the brush head. This allows a softer material to be resting and rubbing on the alveolus and gingival margin minimising their trauma during use.

In other embodiments, the replacement of the bristles with the retention of the rest of the device may be possible. The set of elastomer bristles and elastomer brush head sections may be structured so that they may be reversibly attached together by the user.

The employment of nylon instead of elastomer tufts on the brush head is an option with this device. They may be formed as filament bristles, for example, end-rounded, tapered, spiral, core-sheath, etc. in other embodiments.

Teeth have a tendency to be tipped slightly more mesially than distally, especially when a tooth has been lost adjacent to the mesial aspect. Therefore, in the demonstrated embodiments FIGS. ’s1, 4-13, the bristle tips are profiled appropriately to optimise their contact with the target sites of either mesial 44 or distal 45 surfaces. The bristle tuft structures are not limited to those demonstrated here as there is a broad range of bristle angles, lengths and tip profiles possible to accomplish the essence of the invention. The angle (Z) FIG. 11 between the longitudinal axis of the bristles 35 and the longitudinal axis of the second and third portions of the secondary members 40B, 40C may vary from 40 degrees to 320 degrees.

The bristles may have antimicrobial properties. The bristles may have plaque repellent properties.

The brush head assembly and first member together may incorporate features allowing it to be compatible with, attached to and for use with electric-powered toothbrushes known in the art, for example, the Philips Sonicare range.

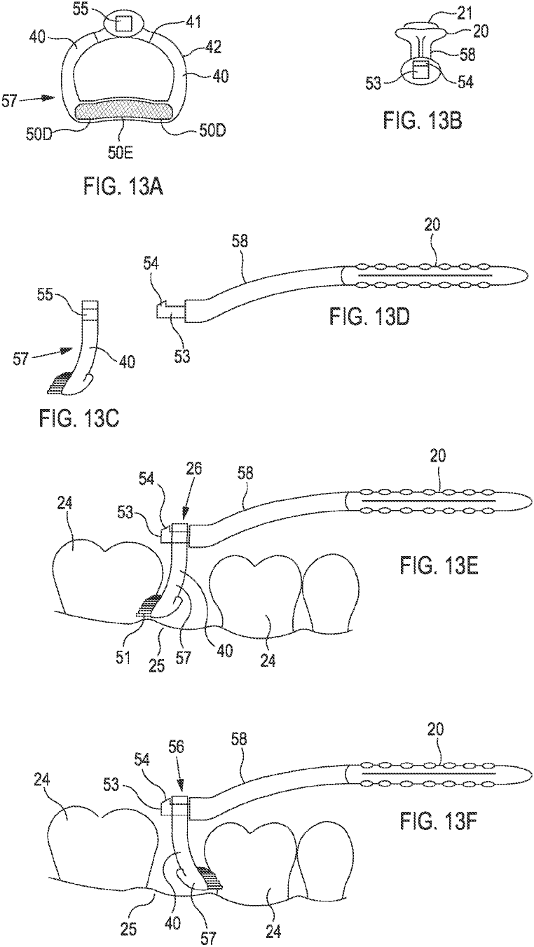

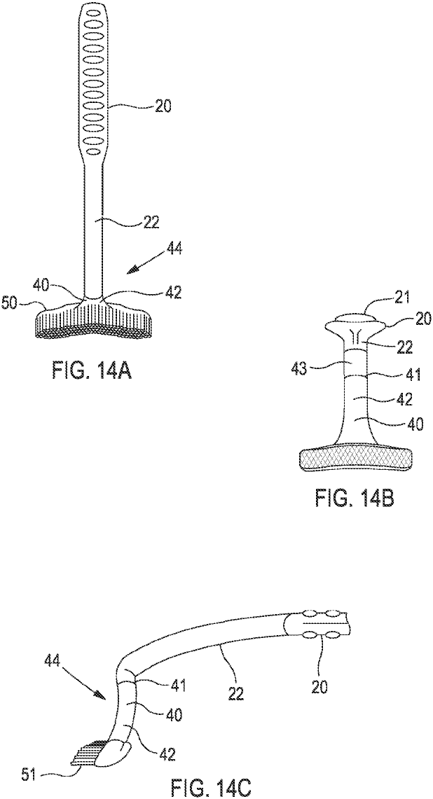

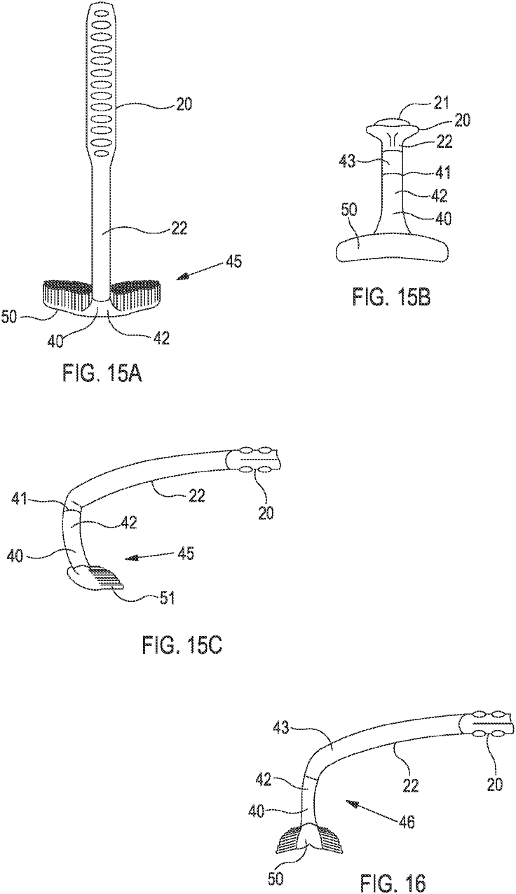

In other embodiments FIGS. ’s13A-13F, a brush head assembly 57 is presented to the user separately from a first member and has a joint 56 to unite the two. The functions of the joint may include allowing the union of the two parts to be reversible; allowing the use of the brush head assembly in mesial cleaning FIG. 13E or distal cleaning configurations FIG. 13F; and, in permanent union of the two parts.

Advantages of having a joint are that the whole device may be presented to the user as two separate pieces and packaged in a more flat and compact state; the whole device may serve in the cleaning of one of, or both, mesial and distal surfaces; the manufacturing cost outlay may be less due to only one specification being required for both mesial and distal surface cleaning versions of the device; and, brush head assemblies may be replaced by the user with the handle and first member parts being retained. With regards specifically to the joint being permanent, this may enhance safety during use of the device and allow it to have a dedicated purpose in mesial or distal surface cleaning once assembled.

The joint may consist of one of the many structures that are known in the art, for example, a sliding dovetail joint. Alternatively, a basic latch 54 with a permanent or reversible latching action may be employed. The joint may be oriented to allow optimal positioning of the brush head assembly for configurations for mesial or distal tooth surface cleaning. The joint may be able to rotate, for example, as in a hinge or pivot joint, and may allow the user to swing the brush head assembly between various positions so that it may serve the purpose of cleaning mesial and distal surfaces.

Any of the said permutations described for any of said embodiments herein also apply to any embodiment which includes the joint feature.

Any part of any embodiment may be made of plastic, elastomer, biodegradable materials or any other material conducive to manufacturing the device and upholding the essence of the invention.

A skilled person will appreciate that variations of the enclosed arrangement are possible without departing from the invention. Accordingly, the above description of the specific embodiment is made by way of example only and not for the purposes of limitations. It will be clear to the skilled person that minor modifications may be made without significant changes to the operation described.

DRAWING REFERENCE NUMERALS

| | |
|---|---|
| 20 | handle or handle portion of elongate member |
| 21 | finger grip |
| 22 | first member or forward portion of elongate member |
| 24 | tooth |
| 25 | gingiva |
| 26 | periodontally diseased and mesially tipped tooth |
| 27 | typical direction of users’ force which seats the device |
| 28 | typical reciprocating brushing motion by users when cleaning these sites |
| 30 | total width of brush head assembly |
| 32 | longitudinal axis of handle or handle axis |
| 33 | longitudinal axis of first member or forward axis |
| 34 | longitudinal axis of second and third portions of secondary member or support member axis |
| 35 | longitudinal axis of bristles or tuft axis |
| 40 | secondary member or support member |
| 40A | first (proximal) portion of secondary member |
| 40B | second (middle) portion of secondary member |
| 40C | third (distal) portion of secondary member |
| 41 | border between elastomeric coating and uncoated plastic |
| 42 | elastomeric material |
| 43 | plastic material |
| 44 | example of brush head assembly for use on mesial surfaces |
| 45 | example of brush head assembly for use on distal surfaces |
| 46 | brush head assembly with double brush head for cleaning of both mesial and distal tooth surfaces |
| 50 | brush head |
| 50D | flat section of brush head |
| SOE | compound curve section of brush head |
| SOF | brush head with constant radius curve |
| 50G | straight brush head |
| 51 | bristles or plurality of tufts |
| 52 | teardrop shaped cross section of brush head |
| 53 | male part of joint at distal end of first member |
| 54 | latch of male part of joint |
| 55 | female part of joint within brush head assembly |
| 56 | assembled joint |
| 57 | brush head assembly for mesial or distal surface cleaning with integrated female part of joint |
| 58 | first member with male part of joint at its distal end |
| 59 | bristles orientated for cleaning of mesial tooth surfaces |
| 60 | bristles orientated for cleaning of distal tooth surfaces |
| W | angle between longitudinal axis of handle (also referred to as a handle axis) and longitudinal axis of first member (also referred to as a forward axis) |
| X | angle between longitudinal axis of handle (also referred to as the handle axis) and longitudinal axis of second and third portions of secondary members (also referred to as a support member axis) |
| Y | angle between longitudinal axis of first member (also referred to as the forward axis) and longitudinal axis of second and third portions of secondary members(also referred to as the support member axis) |
| Z | angle between longitudinal axis of bristles (also referred to as a tuft axis) and longitudinal axis of second and third portions of secondary members (also referred to as the support member axis). |

1. A toothbrush product for cleaning an exposed mesial or distal surface of a tooth or tooth prosthesis comprising:
an elongate member comprising a forward end and a backward end, wherein the elongate member comprises a handle portion and the elongate member extends in a longitudinal direction from the forward end to the backward end;
a brush head, wherein the brush head comprises a plurality of tufts provided at a forward and/or a backward surface of the brush head and
at least one support member for the brush head disposed at the forward end of the elongate member wherein the at least one support member is shaped to support the brush head at a transverse distance from the elongate member, wherein the at least one support member comprises
a proximal portion extending laterally and a distal portion extending transversely thereby to provide a void between the forward end of the elongate member and the brush head across said transverse distance and wherein at least part of the support member extends away from the forward end of the elongate member in the transverse direction such that the void is provided in a substantially transverse plane.

2. A toothbrush product as claimed in claim 1, wherein the at least one support member and brush head comprises a hook or a loop profile.

3. A toothbrush product as claimed in claim 1, further comprising a shoulder coupling between the elongate member and the at least one support member.

4. A toothbrush product as claimed in claim 1, wherein the shoulder coupling couples the elongate portion and the at least one support member such that the at least one support member is projected from the elongate member in a transverse direction at an angle in the range between 15 degrees and 250 degrees, preferably between 80 degrees and 120 degrees.

5. A toothbrush product as claimed in claim 1, wherein the at least one support member comprises a curved profile in the lateral direction and/or a curved profile in the transverse direction.

6. A toothbrush product as claimed in claim 1, wherein the curved profile in the transverse direction and in the lateral direction may be selected to correspond to a curved profile of a tooth or tooth prosthesis, for example a tooth or tooth prosthesis.

7. A toothbrush product as claimed in claim 1, wherein the distal portion of the at least one support member may curve either towards or away from the handle portion.

8. A toothbrush product as claimed in claim 1, wherein the at least one support member comprises a first support member and a second support member disposed on opposing sides of the elongate member and wherein the brush head spans the distance between distal portions of the first and second support members such that at least part of the elongate member, the brush head and the first and second support members form a closed loop.

9. A toothbrush product as claimed in claim 1 further comprising a forward portion disposed between the handle portion and the support member wherein the forward portion is inclined and/or curved relative to the handle portion.

10. A toothbrush product as claimed in claim 1, wherein the brush head extends laterally from the distal end of the support member and comprises a profile that is at least one of a:
curved, concave, convex, tear-drop, arched, flat, straight.

11. A toothbrush product as claimed in claim 1, wherein the plurality of tufts are arranged such that the free ends of the tufts comprise a curved and/or inclined and/or vertical side profile.

12. A toothbrush product as claimed in claim 1, wherein the plurality of tufts are arranged such that tufts provided towards the centre of the brush head are smaller in length relative to tufts provided at either end of the brush head.

13. A toothbrush product as claimed in claim 1, wherein the plurality of tufts are arranged such that the tufts at the most transverse part of the brush head extend further from the brush head surface than tufts provided at the least transverse part of the brush head.

14. A toothbrush product as claimed in claim 1, comprising a first plurality of tufts on the forward surface of the brush head and a second plurality of tufts on the backward surface of the brush head.

15. A toothbrush product as claimed in claim 14, wherein the first plurality of tufts are aligned along a first tuft axis and the second plurality of tufts are aligned along a second tuft axis and the angle between the first tuft axis and the second tuft axis may be in the range from 30 degrees to 280 degrees, preferably in the range 90 degrees to 180 degrees.

16-18. (canceled)

19. A toothbrush product as claimed in claim 1, wherein the elongate member and/or the brush head and/or the at least one support member is manufactured out of at least one of: a biodegradable material, plastic, bamboo, an elastomer, elastomer coated and/or bristles of the plurality of tufts comprise any suitable material, for example, elastomer and/or nylon and/or a microbial material and/or wherein the tufts comprise a material that is plaque repellent and/or wherein the tufts are replaceable.

20. A brush head assembly configured to be coupled to an elongate member comprising a handle portion, wherein the brush head assembly comprises:
a brush head comprising a plurality of tufts provided at a forward and/or a backward surface of the brush head and
at least one support member for the brush head and a brush head assembly coupling for coupling the at least one support member to an elongate member comprising a handle portion, wherein the at least one support member is shaped to provide the brush head at a distance from the brush head assembly coupling and wherein the at least one support member comprises a proximal portion extending laterally and a distal portion extending transversely from the brush head assembly coupling, such that a void is provided between the brush head assembly coupling and the brush head across said distance.

21. The brush head assembly as claimed in claim 20, wherein the brush head assembly is configured to be coupled to an electric toothbrush.

22. A kit of parts comprising:
the brush head assembly according to claim 20 and the elongate member.

23. A kit of parts as claimed in claim 22, wherein the brush head assembly comprises a first mating feature at the brush head assembly coupling and the elongate member comprise a second corresponding mating feature configured to mate to the first mating feature.

24-25. (canceled)
